(19) United States
(12) Patent Application Publication
(10) Pub. No.: US 2025/0372011 A1
(43) Pub. Date: Dec. 4, 2025

(54) Display Apparatus and Display Control Method with Redundancy Repair Function

(71) Applicant: ULTRADISPLAY INC., Hsinchu County (TW)

(72) Inventors: Dsun-Chie Twu, Hsinchu County (TW); Chun-Wang YU, Hsinchu County (TW)

(21) Appl. No.: 19/218,666

(22) Filed: May 27, 2025

Related U.S. Application Data
(60) Provisional application No. 63/652,650, filed on May 28, 2024.

(30) Foreign Application Priority Data
Apr. 1, 2025 (TW) 114112678

(51) Int. Cl. G09G 3/00; G09G 3/32

(52) U.S. Cl. CPC G09G 3/006; G09G 3/32; G09G 2310/08; G09G 2320/0626; G09G 2330/08; G09G 2330/12

(57) ABSTRACT

This invention provides a display apparatus with redundancy repair capability, comprising: a display module including a plurality of display pixel units arranged in M columns and P rows and at least one redundant pixel driving circuit; a nonvolatile memory; and a drive control circuit. The drive control circuit is configured to control the display module to execute a pixel unit redundancy repair procedure, thereby identifying defective pixel units and storing corresponding repair data into the nonvolatile memory. Additionally, during a display procedure, the drive control circuit retrieves the repair data from the nonvolatile memory and controls the plurality of display pixel units and to activate the at least one redundant pixel driving circuit to bypass faulty units, ensuring accurate image displaying based on the repair data and display data.

### CROSS REFERENCE

The present invention claims priority to provisional application 63/652,650 filed on May 28 2024, and TW 114112678 filed on Apr. 1, 2025.

### BACKGROUND OF THE INVENTION

Field of Invention

The present invention relates to a display apparatus, and more particularly, to a display apparatus with redundancy repair functionality. The present invention also relates to a display control method featuring redundancy repair capability.

### Description of Related Art

Conventional display panels typically employ thin-film transistors (TFTs) as the driving substrate. However, the performance of TFT technology has gradually encountered limitations in applications requiring high pixel density (pixels per inch, PPI), making it increasingly difficult to meet the demands of modern high-resolution displays. In contrast, microdisplays adopt complementary metal-oxide-semiconductor (CMOS) as the driving substrate, effectively addressing the challenges associated with high-PPI displays and thereby enabling broader adoption in consumer, commercial, and military applications involving augmented reality (AR), virtual reality (VR), and mixed reality (MR). Moreover, the CMOS-based driving substrate incorporates Memory-in-Pixel (MIP) technology, wherein embedded memory is distributed within each pixel unit to store the data required for pixel display. This design enhances display performance and reduces the frequency of external data access, thereby contributing to lower overall power consumption.

However, in prior art microdisplays, the light-emitting driver elements and embedded pixel memory remain constrained by manufacturing processes and device performance. If the light-emitting driver or the Memory-in-Pixel (MIP) becomes damaged, it may cause the entire driving apparatus or display backplane to malfunction, thereby degrading image output quality or even leading to complete device failure. Therefore, enhancing the reliability of microdisplays and ensuring the stability of light-emitting drivers and embedded memory is a critical issue in the current state of the art.

In view of the foregoing, the present invention addresses the shortcomings of prior art by providing a display apparatus incorporating embedded pixel memory and light-emitting driving circuits, wherein a redundancy repair mechanism is employed to improve the production yield of the display apparatus and to ensure the integrity of the output image quality.

### SUMMARY OF THE INVENTION

From one perspective, the present invention provides a display apparatus, comprising a display module including a plurality of display pixel units physically arranged in M columns and P rows, and at least one redundant pixel driving circuit; a nonvolatile memory; and a drive control circuit configured to control the display module to execute a pixel unit redundancy repair procedure for obtaining and storing repair data in the nonvolatile memory, and configured to, during a display procedure, read the repair data from the nonvolatile memory and control the plurality of display pixel units and the at least one redundant pixel driving circuit for image display based on the repair data and display data.

In one preferred embodiment, each of the plurality of display pixel units comprises a pixel unit memory configured to store a portion of the display data corresponding to the display pixel unit; a primary pixel driving circuit including Q sub-pixel driving circuits, where Q is an integer greater than or equal to 1; a drive repair circuit coupled to the primary pixel driving circuit and the at least one redundant pixel driving circuit; a pixel circuit coupled to the drive repair circuit, including Q corresponding light-emitting diodes (LEDs); and a pixel unit logic circuit coupled to the pixel unit memory, the primary pixel driving circuit, and the at least one redundant pixel driving circuit. During the display procedure, the pixel unit logic circuit, under control of the drive control circuit, reads and converts the corresponding portion of the display data from the pixel unit memory to generate a dimming signal, and when at least one of the Q sub-pixel driving circuits is determined to be faulty, the pixel unit logic circuit controls the drive repair circuit based on the repair data to electrically connect the non-faulty portion of the Q sub-pixel driving circuits and the at least one redundant pixel driving circuit to the corresponding Q LEDs, and controls the non-faulty portion of the Q sub-pixel driving circuits and the at least one redundant pixel driving circuit based on the dimming signal to generate Q corresponding driving currents for driving the Q LEDs to emit light.

In one preferred embodiment, each of the display pixel units further includes one of the at least one redundant pixel driving circuit; or the display module includes R′ redundant pixel driving circuits, where R′ is greater than 1 and less than the product of M and P, such that each of the R′ redundant pixel driving circuits is shared by a predetermined number of the display pixel units.

In one preferred embodiment, the pixel unit redundancy repair procedure includes a driving circuit redundancy repair procedure. The driving circuit redundancy repair procedure includes controlling at sub-pixel driving circuits to generate a test current for driving the corresponding light-emitting diode to emit light; determining whether the sub-pixel driving circuit is faulty based on the brightness of the light-emitting diode or the level of the test current; and when determined to be faulty, determining corresponding repair data based on a driver fault address of the faulty sub-pixel driving circuit. The repair data includes the driver fault address and mapping information to a corresponding one of the at least one redundant pixel driving circuits as a replacement.

In one preferred embodiment, each of the sub-pixel driving circuits and the at least one redundant pixel driving circuit includes a reference drive current source and a dimming transistor serially coupled to the drive repair circuit. During the display procedure, the pixel unit logic circuit is configured to control the dimming transistor based on the dimming signal to generate the driving current from the reference drive current source, thereby driving the corresponding light-emitting diode to emit light with a corresponding intensity.

In one preferred embodiment, the dimming signal is configured to linearly control or pulse-width modulate the dimming transistor to adjust the light intensity of the light-emitting diode.

In one preferred embodiment, the drive repair circuit includes a plurality of path control switches coupled among the Q sub-pixel driving circuits, the at least one redundant pixel driving circuit, and the Q light-emitting diodes. The pixel unit logic circuit is configured to generate corresponding path control signals based on the repair data to control the path control switches so as to turn off the faulty sub-pixel driving circuit and turn on a corresponding one of the at least one redundant pixel driving circuits to generate the corresponding driving current for driving the corresponding light-emitting diode to emit light.

In one preferred embodiment, the pixel unit memory includes a primary pixel memory including T primary memory bits, where T is an integer greater than or equal to 1; and a redundant pixel memory including R redundant memory bits, where R is an integer greater than or equal to 1. During the display procedure, when at least one of the T primary memory bits is determined to be faulty, the pixel unit logic circuit controls the non-faulty portion of the T primary memory bits and the R redundant memory bits to collaborate based on the repair data for storing or retrieving the display data.

In one preferred embodiment, the pixel unit redundancy repair procedure includes a pixel memory redundancy repair procedure. The pixel memory redundancy repair procedure includes performing a read/write test on the primary pixel memory to determine whether any of the primary memory bits are faulty; and when a fault is determined, determining corresponding repair data based on a memory bit fault address of the faulty one of the primary memory bits, wherein the repair data includes the memory bit fault address and mapping information to a corresponding one of the redundant memory bits as a replacement.

In one preferred embodiment, the display module and the drive control circuit are integrally manufactured on a single chip, and the pixel unit memory, the primary pixel driving circuit, the drive repair circuit, the pixel circuit, the pixel unit logic circuit, and the corresponding one of the at least one redundant pixel driving circuit within each of the display pixel units are physically located in proximity to one another.

From another perspective, the present invention provides a display apparatus, comprising a display module including a plurality of display pixel units physically arranged in M columns and P rows, wherein each of the plurality of display pixel units includes a pixel unit memory and a pixel unit logic circuit, the pixel unit memory configured to store a portion of display data corresponding to the display pixel unit, and the pixel unit logic circuit being coupled to the pixel unit memory. The pixel unit memory comprises a primary pixel memory including T primary memory bits, where T is an integer greater than or equal to 1; and a redundant pixel memory including R redundant memory bits, where R is an integer greater than or equal to 1. The apparatus further comprises a nonvolatile memory; and a drive control circuit configured to control the display module to execute a pixel memory redundancy repair procedure for obtaining and storing repair data in the nonvolatile memory, and configured to, during a display procedure, read the repair data from the nonvolatile memory and control the plurality of display pixel units to perform image display based on the repair data and the display data. During the display procedure, when at least one of the T primary memory bits is determined to be faulty, the pixel unit logic circuit controls the non-faulty portion of the T primary memory bits and the R redundant memory bits to cooperate based on the repair data for storing or retrieving the display data.

In one preferred embodiment, the pixel unit redundancy repair procedure includes a pixel memory redundancy repair procedure. The pixel memory redundancy repair procedure includes performing a read/write test on the primary pixel memory to determine whether any of the primary memory bits are faulty; and when a fault is determined, determining corresponding repair data based on a memory bit fault address of the faulty one of the primary memory bits, wherein the repair data includes the memory bit fault address and mapping information to a corresponding one of the redundant memory bits as a replacement.

From another perspective, the present invention provides a display control method for controlling a display module, wherein the display module includes a plurality of display pixel units physically arranged in M columns and P rows and at least one redundant pixel driving circuit. The display control method comprises: controlling the display module to execute a pixel unit redundancy repair procedure to obtain and store repair data in a nonvolatile memory; and during a display procedure, reading the repair data from the nonvolatile memory and controlling the plurality of display pixel units and the at least one redundant pixel driving circuit to perform image display based on the repair data and display data.

In one preferred embodiment, each of the plurality of display pixel units includes a pixel unit memory configured to store a portion of the display data corresponding to the display pixel unit, wherein the display procedure includes: reading and converting the portion of the display data from the pixel unit memory to generate a dimming signal. Each of the display pixel units further includes a primary pixel driving circuit and the at least one redundant pixel driving circuit, and the primary pixel driving circuit includes Q sub-pixel driving circuits, where Q is an integer greater than or equal to 1. When at least one of the Q sub-pixel driving circuits in the primary pixel driving circuit is determined to be faulty, the non-faulty portion of the Q sub-pixel driving circuits and the redundant pixel driving circuit are electrically connected to a pixel circuit including corresponding Q light-emitting diodes (LEDS) based on the repair data. The non-faulty portion of the Q sub-pixel driving circuits and the redundant pixel driving circuit are then controlled based on the dimming signal to generate Q corresponding driving currents to drive the Q LEDs to emit light.

In one preferred embodiment, the pixel unit redundancy repair procedure includes a driving circuit redundancy repair procedure. The driving circuit redundancy repair procedure comprises: controlling at least one of the Q sub-pixel driving circuits to generate a test current for driving the corresponding light-emitting diode to emit light; determining whether the sub-pixel driving circuit is faulty based on the brightness of the light-emitting diode or the level of the test current; and when determined to be faulty, determining corresponding repair data based on a driver fault address of the faulty sub-pixel driving circuit, wherein the repair data includes the driver fault address and mapping information to a corresponding one of the at least one redundant pixel driving circuit as a replacement.

In one preferred embodiment, the display procedure includes: disabling the at least one faulty sub-pixel driving circuit based on the repair data, and controlling the redundant pixel driving circuit to generate the corresponding driving current to drive the corresponding light-emitting diode to emit light.

In one preferred embodiment, the pixel unit memory, the primary pixel driving circuit, the pixel circuit, and the corresponding redundant pixel driving circuit in each of the display pixel units are physically located in proximity to one another.

From another perspective, the present invention provides a display control method for controlling a display module, wherein the display module includes a plurality of display pixel units physically arranged in M columns and P rows. The display control method comprises: controlling the display module to execute a pixel memory redundancy repair procedure to obtain and store repair data in a nonvolatile memory. Each of the plurality of display pixel units includes a pixel unit memory configured to store a portion of display data corresponding to the display pixel unit. The pixel unit memory includes a primary pixel memory including T primary memory bits, where T is an integer greater than or equal to 1, and a redundant pixel memory including R redundant memory bits, where R is an integer greater than or equal to 1. During a display procedure, the repair data is read from the nonvolatile memory and used to control the plurality of display pixel units to perform image display based on the repair data and the display data. The display procedure includes: when at least one of the T primary memory bits is determined to be faulty, controlling, based on the repair data, the non-faulty portion of the T primary memory bits and the R redundant memory bits to collaborate to store or retrieve the display data.

### BRIEF DESCRIPTION OF THE DRAWINGS

FIG. 1 illustrates a block diagram of a display apparatus according to one embodiment of the present invention.

FIG. 2 illustrates a block diagram of a display pixel unit in a display apparatus according to one embodiment of the present invention.

FIG. 3 illustrates a block diagram of a display apparatus according to another embodiment of the present invention.

FIG. 4 illustrates a circuit diagram of a display pixel unit according to one specific embodiment of the present invention.

FIG. 5 illustrates a circuit diagram of an embodiment of a display pixel unit corresponding to FIG. 3.

FIG. 6 illustrates a diagram of a specific embodiment of a drive repair circuit in the display pixel unit corresponding to FIG. 4.

FIG. 7 illustrates a diagram of a specific embodiment of a drive repair circuit in the display pixel unit corresponding to FIG. 5.

FIG. 8 illustrates a test flowchart of a display apparatus according to one embodiment of the present invention.

FIG. 9 illustrates a test flowchart of a sub-pixel driving circuit in a display apparatus according to one embodiment of the present invention.

FIG. 10A illustrates a flowchart of a display procedure according to one embodiment of the display apparatus of the present invention, which corresponds to the display procedures shown in FIG. 8 or FIG. 9.

FIG. 10B illustrates a flowchart of a display procedure according to one embodiment of the display apparatus of the present invention.

FIG. 10C illustrates a flowchart of a display procedure

according to one embodiment of the display apparatus of the present invention.

FIG. 11A illustrates a circuit diagram of a display pixel unit according to one embodiment of the present invention.

FIG. 11B illustrates a block diagram of a pixel unit logic circuit array composed of P rows and M columns.

FIG. 11C illustrates a block diagram of a display pixel memory array according to one embodiment of the present invention.

FIG. 12A illustrates a partial circuit of the pixel unit logic circuit.

FIG. 12B illustrates a waveform diagram corresponding to the partial circuit of the pixel unit logic circuit shown in FIG. 12A.

FIG. 13A illustrates a partial circuit of the pixel unit logic circuit according to one embodiment of the present invention.

FIG. 13B illustrates a waveform diagram corresponding to FIG. 13A.

FIG. 14 illustrates control signal waveforms of the display pixel memory according to one embodiment of the present invention.

FIG. 15 illustrates a waveform diagram of a fault condition according to one embodiment of the present invention.

FIG. 16 illustrates another waveform diagram of a fault condition according to one embodiment of the present invention.

### DESCRIPTION OF THE PREFERRED EMBODIMENTS

The drawings as referred to throughout the description of the present invention are for illustration only, to show the interrelations between the circuits and the signal waveforms, but not drawn according to actual scale of circuit sizes and signal amplitudes and frequencies.

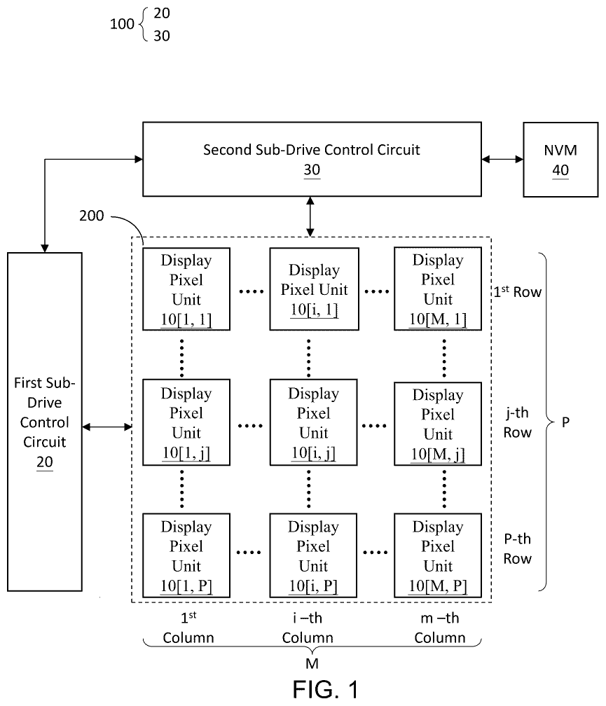

FIG. 1 illustrates a display apparatus comprising a display module 200, a nonvolatile memory 40, and a drive control circuit 100. The drive control circuit 100 includes a first sub-drive control circuit 20 and a second sub-drive control circuit 30. The first sub-drive control circuit 20 is disposed along the row direction and is configured for transmitting and receiving control signals in the row direction to control the display module 200. The second sub-drive control circuit 30 is disposed along the column direction and is configured for transmitting and receiving control signals in the column direction to control the display module 200. The display module 200 includes a plurality of display pixel units 10 to 10 arranged in M columns and P rows.

The display apparatus is further configured to perform a pixel unit redundancy repair procedure, which is used to test and detect fault conditions within the display pixel units 10 to 10, such as faults in the driving circuits or memories within the pixel units. During the testing procedure, the drive control circuit 100 stores these fault conditions as repair data into the nonvolatile memory 40. During a display procedure, the drive control circuit 100 retrieves the repair data from the nonvolatile memory 40 and, based on the repair data and the received display data, controls the display pixel units 10 to 10 and the redundant pixel driving circuit 104. Notably, according to the present invention, the drive control circuit 100 can utilize the redundant pixel driving circuit 104 or redundant pixel memory to respectively replace faulty driving circuits or memories in the display module 200 for image rendering, thereby ensuring proper operation and display quality. The detailed structure and operation of the redundant circuit will be described in subsequent paragraphs.

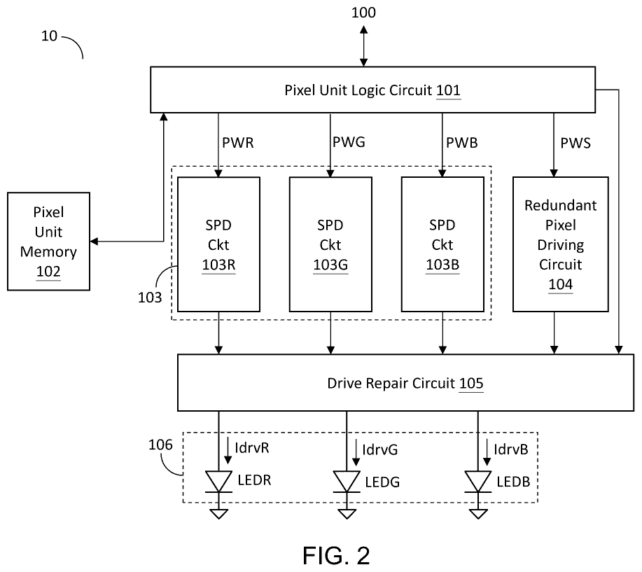

Please refer to FIG. 1 and FIG. 2 together. FIG. 2 illustrates a block diagram of one embodiment of a display pixel unit in the display apparatus. The display pixel unit 10 includes a pixel unit logic circuit 101, a pixel unit memory 102, a primary pixel driving circuit 103, a redundant pixel driving circuit 104, a drive repair circuit 105, and a pixel circuit 106. In the embodiment shown in FIG. 2, each display pixel unit 10 includes a dedicated redundant pixel driving circuit 104. The pixel unit memory 102 is configured to store a portion of the display data corresponding to the respective display pixel unit 10. Notably, in one embodiment, the pixel unit memory 102 is disposed in each display pixel unit, thereby distributing the display data across the display pixel units. This configuration can effectively reduce memory access power consumption during display procedures, thereby lowering overall power usage of the display apparatus.

The primary pixel driving circuit 103 includes Q sub-pixel driving circuits (SPD Ckt). For example, in this embodiment, Q is 3, represented as 103R, 103G, and 103B in FIG. 2, which are configured to respectively drive the light-emitting diodes LEDR, LEDG, and LEDB under normal (non-faulty) conditions. The drive repair circuit 105 is coupled to the primary pixel driving circuit 103 and the redundant pixel driving circuit 104. When at least one of the sub-pixel driving circuits 103R, 103G, or 103B fails, the drive repair circuit 105 reconfigures the electrical connections of the non-faulty sub-pixel driving circuits and the redundant pixel driving circuit 104 to the LEDS LEDR, LEDG, and LEDB based on the repair data, and further generates corresponding driving currents IdrvR, IdrvG, and IdrvB to drive the LEDs to emit light, as will be described in detail later. In one embodiment, the display module and the drive control circuit are integrally manufactured on a single chip, and the pixel unit memory, the primary pixel driving circuit, the drive repair circuit, the pixel circuit, the pixel unit logic circuit, and the corresponding one of the at least one redundant pixel driving circuit within each of the display pixel units are physically located in proximity to one another.

In the pixel unit redundancy repair procedure, the pixel unit logic circuit 101, under the control of the drive control circuit 100, controls the primary pixel driving circuit 103 to perform a driving operation and determines whether any of the sub-pixel driving circuits 103R, 103G, and 103B in the primary pixel driving circuit 103 are faulty based on the result. Upon detecting a fault, the pixel unit logic circuit 101 reports the fault information to the drive control circuit 100, which then converts the fault information into repair data and stores it in the nonvolatile memory 40.

On the other hand, during the display procedure, the pixel unit logic circuit 101 receives display data from the drive control circuit 100 and stores it in the pixel unit memory 102. The pixel unit logic circuit 101 also receives the repair data stored in the nonvolatile memory 40. Based on this repair data, the pixel unit logic circuit 101 controls the drive repair circuit 105 to determine whether the redundant pixel driving circuit 104 should be activated to replace the faulty sub-pixel driving circuit. If the repair operation is initiated, the pixel unit logic circuit 101 controls the non-faulty sub-pixel driving circuits and the redundant pixel driving circuit 104 based on a dimming signal to generate corresponding driving currents IdrvR, IdrvG, and IdrvB for driving the LEDS LEDR, LEDG, and LEDB, thereby ensuring the display function even in the presence of faults.

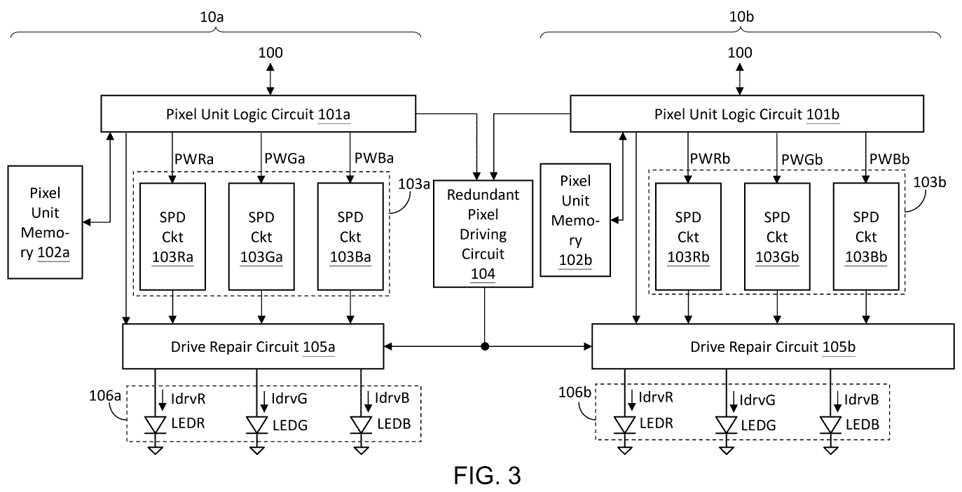

FIG. 3 illustrates another embodiment of the display apparatus, which has a structure similar to that in FIG. 2. In the embodiment of FIG. 3, the number of redundant pixel driving circuits 104 in the display module is fewer than the number of display pixel units 10, and a shared design is adopted.

Specifically, FIG. 3 shows two display pixel units 10a and 10b, where each display pixel unit includes a pixel unit logic circuit 101 (101a, 101b), a pixel unit memory 102 (102a, 102b), a primary pixel driving circuit 103 (103a, 103b), and a pixel circuit 106 (106a, 106b), but does not include a dedicated redundant pixel driving circuit. Instead, the display pixel units 10a and 10b share an external redundant pixel driving circuit 104. When a sub-pixel driving in either primary pixel driving circuit 103a or 103b fails, the respective drive repair circuit 105a or 105b in display pixel units 10a or 10b reconfigures the electrical connection between the non-faulty sub-pixel driving circuits and the shared redundant pixel driving circuit 104 based on the repair data, and generates corresponding driving currents to drive the corresponding LEDs. This embodiment reduces the number of redundant pixel driving circuits while maintaining the functional integrity and image quality of the display apparatus. The sharing ratio may be adjusted according to fault coverage requirements and cost considerations.

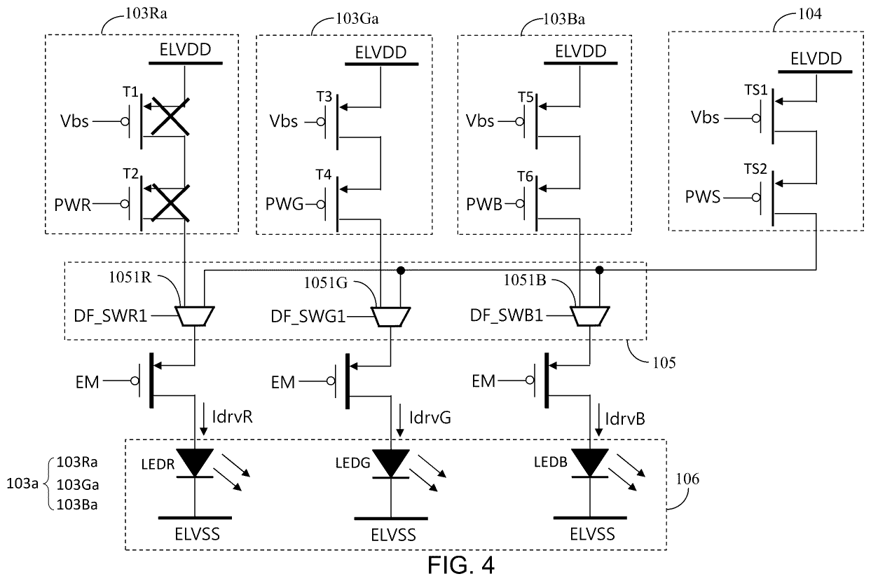

FIG. 4 illustrates a specific embodiment of the display pixel unit driving structure described in FIG. 2. This embodiment describes in detail the structure and operation of the primary pixel driving circuit 103, the redundant pixel driving circuit 104, and the drive repair circuit 105.

In this embodiment, the primary pixel driving circuit 103 further includes sub-pixel driving circuits 103Ra, 103Ga, and 103Ba, which are configured to drive the LEDS LEDR, LEDG, and LEDB during normal operation. Each of the sub-pixel driving circuits 103Ra, 103Ga, and 103Ba includes a two-stage transistor driving structure. Specifically, the sub-pixel driving circuit 103Ra includes transistors T1 and T2, 103Ga includes transistors T3 and T4, and 103Ba includes transistors T5 and T6.

Transistors T1, T3, and T5 are controlled by a bias voltage Vbs to provide a fixed DC bias current. Transistors T2, T4, and T6 are connected in series below transistors T1, T3, and T5, respectively, and are controlled by dimming signals PWR (for red), PWG (for green), and PWB (for blue), to adjust the driving currents according to dimming requirements, thereby controlling the brightness of the LEDS LEDR, LEDG, and LEDB.

The redundant pixel driving circuit 104 also adopts a similar structure, including transistors TS1 and TS2. TS1 is controlled by the bias voltage Vbs to provide a fixed bias current, while TS2 is controlled by the dimming signal PWS to provide backup driving current to the target LED when needed.

During normal operation, the sub-pixel driving circuits 103Ra, 103Ga, and 103Ba are electrically connected to the LEDS LEDR, LEDG, and LEDB through the drive repair circuit 105, which includes multiplexers 1051a, 1051b, and 1051c, to supply driving currents IdrvR, IdrvG, and IdrvB, respectively. In this embodiment, each LED is connected in series with a control switch between its upper terminal and the drive repair circuit 105. The control switch is controlled by an enable signal EM to determine whether the driving current is conducted.

To simulate a fault in the primary pixel driving circuit, FIG. 4 illustrates a fault condition in sub-pixel driving circuit 103Ra. In this case, transistors T1 or T2 malfunctions and cannot provide a normal driving current. The pixel unit logic circuit 101 consequently controls the redundant pixel driving circuit 104 to replace the faulty sub-pixel driving circuit 103Ra, and redirects the control waveform of dimming signal PWR to dimming signal PWS to drive transistor TS2 to generate a corresponding replacement driving current. Furthermore, the drive repair circuit 105 (i.e., the multiplexer) selects the replacement driving current from the redundant pixel driving circuit 104 as IdrvR under the control of the pixel unit logic circuit 101, while IdrvG and IdrvB remain provided by sub-pixel driving circuits 103Ga and 103Ba, respectively, thereby completing the repair operation during the display procedure and maintaining display stability.

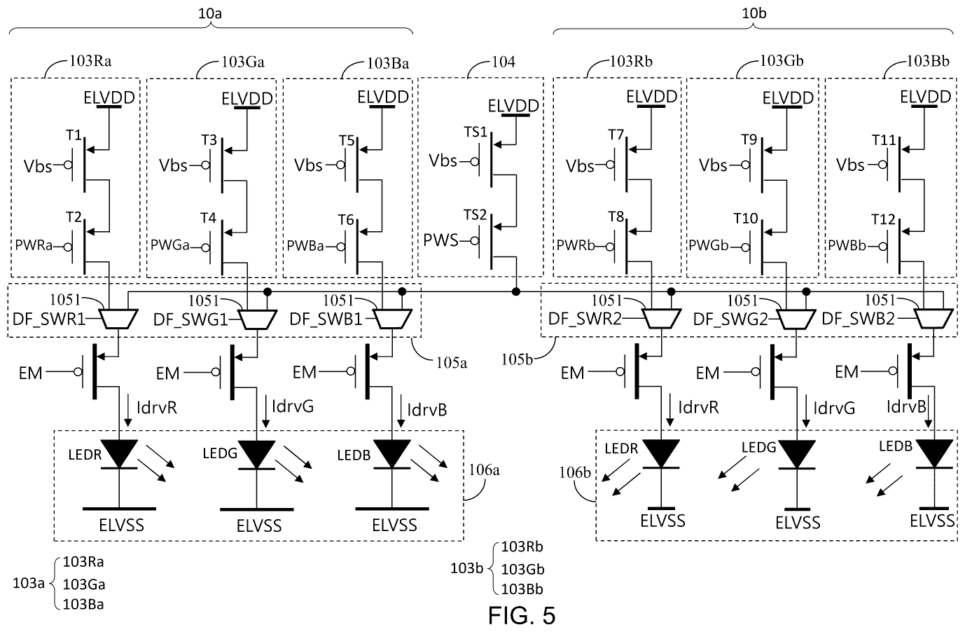

FIG. 5 illustrates an embodiment of a specific display pixel unit driving structure corresponding to FIG. 3. This embodiment is similar to that in FIG. 4, and differs in that the redundant pixel driving circuit 104 is shared by multiple display pixel units rather than being independently included in each unit.

In this embodiment, the left half of FIG. 5 shows a display pixel unit 10a, the right half shows another display pixel unit 10b, and the center shows a shared redundant pixel driving circuit 104. The output of the redundant pixel driving circuit 104, namely the drain of transistor TS2, is coupled to the drive repair circuits 105a and 105b of display pixel units 10a and 10b, respectively. More specifically, the output of the redundant pixel driving circuit 104 is coupled to multiplexers within drive repair circuits 105a and 105b, which are configured to select whether to use the redundant pixel driving circuit 104 as the driving current source to replace the faulty sub-pixel driving circuit in display pixel unit 10a or 10b. The driving operation in this embodiment is similar to that in FIG. 4 and is not described again here.

In the embodiment of FIG. 5, two display pixel units 10a and 10b share a redundant pixel driving circuit 104. In other embodiments, a single redundant pixel driving circuit may be shared with a larger number of display pixel units to improve redundancy circuit utilization and reduce overall circuit cost.

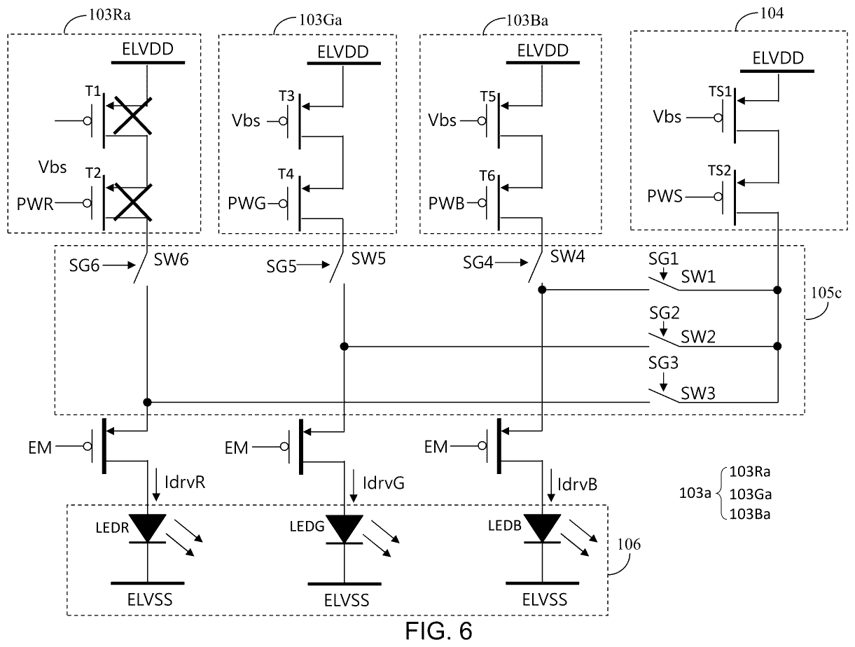

FIG. 6 illustrates a specific embodiment of the drive repair circuit in the display pixel unit corresponding to FIG. 4. In this embodiment, the drive repair circuit 105c includes six multiplexer selection switches SW1 to SW6. Switches SW1, SW2, and SW3 are configured to select whether the redundant pixel driving circuit 104 provides the replacement driving current, which is routed to the corresponding LEDs LEDB, LEDG, or LEDR. Switches SW4, SW5, and SW6 correspond to the sub-pixel driving circuits 103Ba, 103Ga, and 103Ra, respectively, and are configured to select whether the primary pixel driving circuit 103 provides the driving current.

During normal operation, switches SW4, SW5, and SW6 are turned on, while switches SW1, SW2, and SW3 are turned off. In this state, the display pixel unit receives driving current from sub-pixel driving circuits 103Ra, 103Ga, and 103Ba to respectively drive LEDS LEDB, LEDG, and LEDR.

When, for example, sub-pixel driving circuit 103Ra fails, the switch states in the drive repair circuit 105c are adjusted: switch SW6 is turned off, and switch SW3 is turned on, allowing the redundant pixel driving circuit 104 to replace the faulty sub-pixel driving circuit 103Ra to provide the driving current. Meanwhile, switches SW4 and SW5 remain on, and switches SW1 and SW2 remain off, allowing 103Ba and 103Ga to continue providing normal driving currents. Other details of this embodiment are similar to those in FIG. 4 and will not be repeated here.

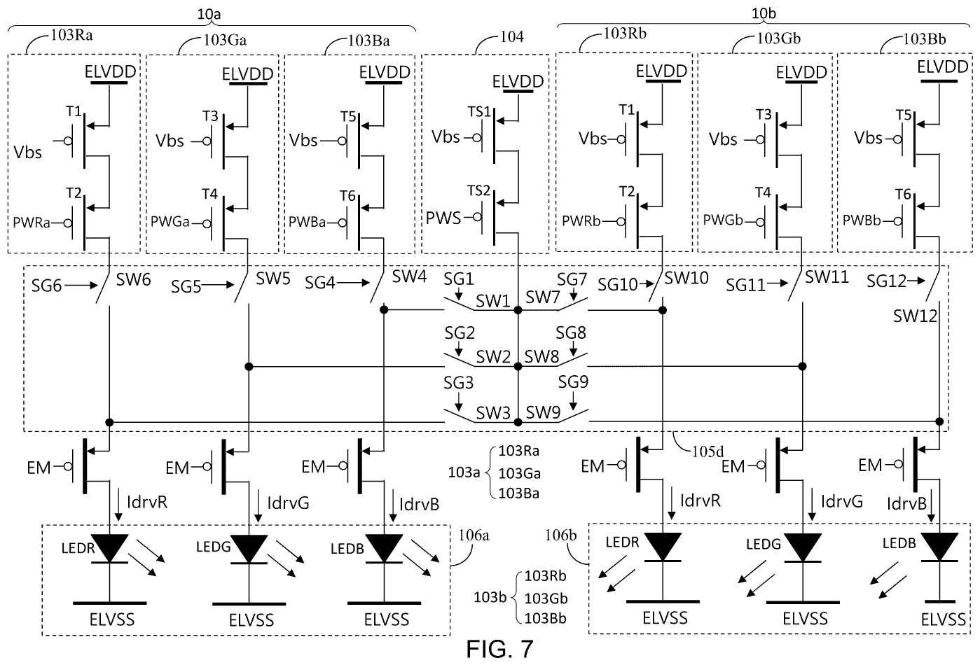

FIG. 7 illustrates a specific embodiment of the drive repair circuit in the display pixel unit corresponding to FIG. 5. This embodiment illustrates the structure and operation of drive repair circuits 105a and 105b in a scenario where multiple display pixel units share a single redundant pixel driving circuit.

In this embodiment, display pixel units 10a and 10b include drive repair circuits 105a and 105b, respectively. Each of the drive repair circuits includes twelve multiplexer selection switches SW1 to SW12. The display pixel units 10a and 10b share the redundant pixel driving circuit 104 through these switches to ensure that, when a fault occurs in one of the pixel units, compensation can still be performed through the repair mechanism. Other details are similar to those in FIGS. 5 and 6 and will not be repeated here.

In the embodiments of FIGS. 6 and 7, the multiplexer selection switches SW1 to SW12 are respectively controlled by switch control signals SG1 to SG12 generated by the pixel unit logic circuit 101. Through the above operations, the drive repair circuit dynamically selects the source of the drive current based on the control of the pixel unit logic circuit.

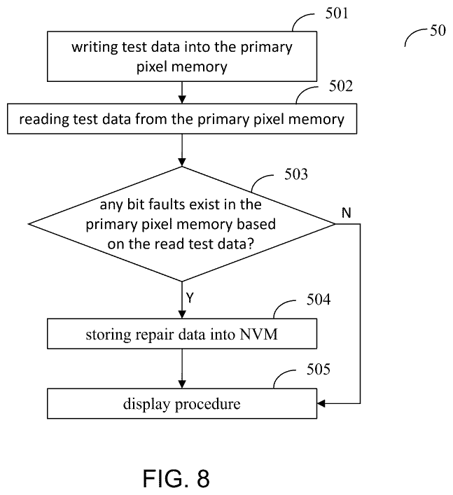

FIG. 8 illustrates a flowchart of a pixel memory redundancy repair procedure of the pixel unit redundancy repair procedure according to one embodiment of the display apparatus of the present invention. The pixel memory redundancy repair procedure 50 in FIG. 8 shows a pre-test procedure for detecting potential faults in the primary pixel memory. Please also refer to FIGS. 1 and 2. First, in step 501, the system writes test data into the primary pixel memory through the aforementioned pixel unit logic circuit 101 to check for faults. Next, in step 502, the pixel unit logic circuit 101 reads the previously written test data from the primary pixel memory. Then, in step 503, the system determines whether any bit faults exist in the primary pixel memory based on the read test data. If a fault is detected in step 503, the procedure proceeds to step 504 to store the corresponding repair data (e.g., address of faulty primary memory bit and mapping information to the redundant memory bit) into the nonvolatile memory (NVM) 40 for future reference. If no faults are detected, the procedure directly proceeds to step 505 to execute the normal display procedure. This pixel memory redundancy repair procedure ensures that necessary repair data is obtained in advance before the display procedure starts. It is noted that the pixel memory redundancy repair procedure 50 is preferably performed on all display pixel units 10 in FIG. 1.

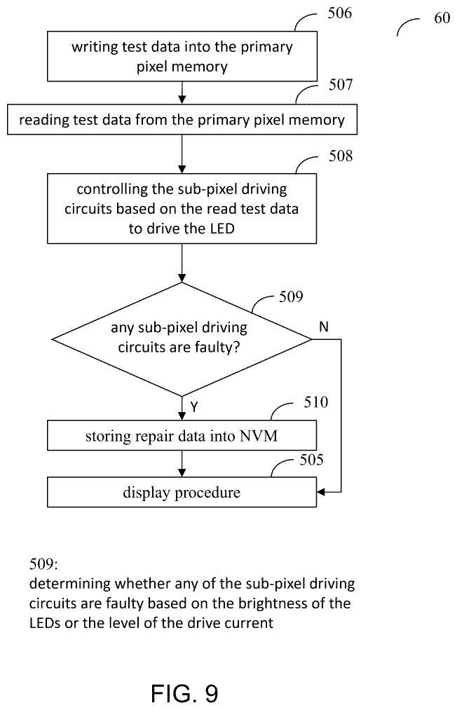

Please also refer to FIGS. 1, 2, and 9. FIG. 9 shows a flowchart of a driving circuit redundancy repair procedure of the pixel unit redundancy repair procedure according to one embodiment of the display apparatus of the present invention. The flowchart 60 in FIG. 9 illustrates a pre-test procedure for detecting potential faults in the sub-pixel driving circuits, to verify whether the sub-pixel driving circuits 103R, 103G, and 103B in the primary pixel driving circuit 103 can correctly generate the corresponding drive currents based on the test data. First, in step 506, the system writes test data into the pixel unit memory 102 through the pixel unit logic circuit 101. Then, in step 507, the pixel unit logic circuit 101 reads the previously written test data from the pixel unit memory 102.

Subsequently, in step 508, the pixel unit logic circuit 101 controls the sub-pixel driving circuits 103R, 103G, and 103B in the primary pixel driving circuit 103 based on the read test data to drive the LEDs. In step 509, the system determines whether any of the sub-pixel driving circuits 103R, 103G, or 103B are faulty based on the brightness of the LEDS or the level of the drive current. If any faults are detected in step 509, the procedure proceeds to step 510 to store the corresponding repair data (e.g., address of faulty sub-pixel driving circuit and mapping information to the redundant pixel driving circuit) into the nonvolatile memory (NVM) 40 for future reference. If no faults are detected, the procedure directly proceeds to step 505 to perform a normal display procedure.

The pixel unit redundancy repair procedure ensures that the operating status of the sub-pixel driving circuits is tested and recorded in advance before the display procedure starts, enabling substitute driving when faults occur, thereby enhancing the reliability of the display apparatus. It is noted that the pixel unit redundancy repair procedure 60 is preferably performed on all display pixel units 10 in FIG. 1.

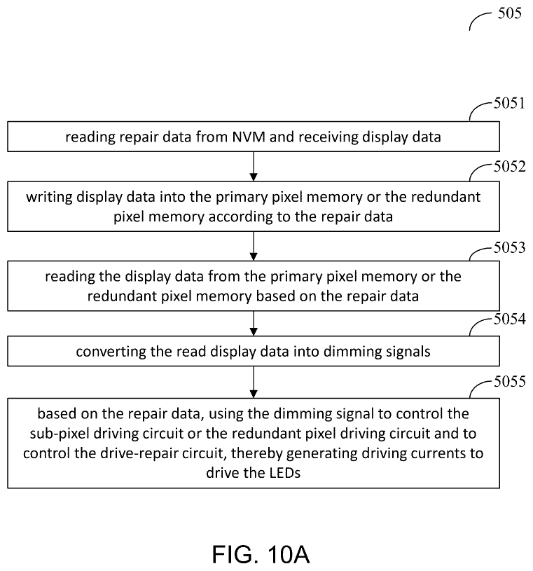

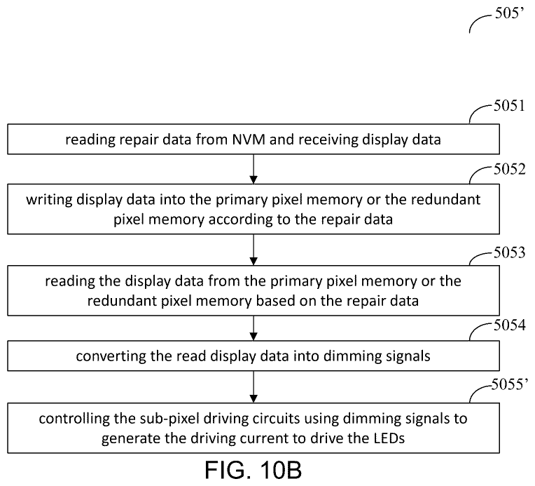

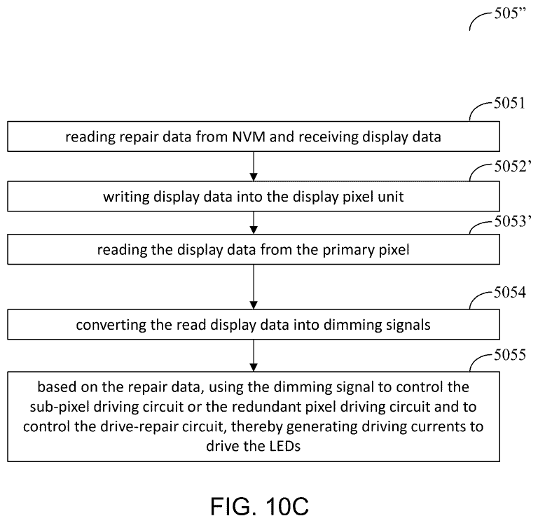

FIG. 10A shows a flowchart of a display procedure according to one embodiment of the display apparatus of the present invention, corresponding to the display procedures in FIG. 8 or 9. The flowchart in FIG. 10A illustrates how the display data is read and converted based on the repair data during a display procedure to ensure correct driving. Please also refer to FIGS. 1 and 2. First, in step 5051, the system (e.g., the drive control circuit) reads the repair data from the nonvolatile memory (NVM) 40 and receives the display data.

Next, in step 5052, the drive control circuit writes the display data into the display pixel unit memory 102 through the corresponding pixel unit logic circuit 101 according to the repair data. If part of the display pixel unit memory 102 is faulty, the data may be written into the redundant pixel memory to ensure proper processing in subsequent display procedures. Then, in step 5053, the pixel unit logic circuit 101 reads the display data from the primary pixel memory or the redundant pixel memory based on the repair data.

In step 5054, the pixel unit logic circuit 101 converts the read display data into dimming signals (such as PWR, PWG, PWB, PWS) to control the sub-pixel driving circuits or the redundant pixel driving circuit 104. Finally, in step 5055, the pixel unit logic circuit 101 uses the dimming signals to controls the sub-pixel driving circuits or the redundant pixel driving circuit 104 according to the repair data, and simultaneously controls the drive repair circuit 105 to generate the driving currents (IdrvR, IdrvG, IdrvB) for driving the corresponding LEDS (LEDR, LEDG, LEDB).

This embodiment ensures that, during the display procedure, the display apparatus can perform appropriate repair and adjustment on the pixel unit memory 102 and/or the driving circuits based on the repair data to ensure correctness of the display driving.

FIG. 10B shows a flowchart of a display procedure according to one embodiment of the display apparatus of the present invention. Please also refer to FIGS. 1 and 2. This embodiment is similar to the flow in FIG. 10A, and differs in that, in this embodiment, the redundant pixel driving circuit 104 and the drive repair circuit 105 in FIG. 2 are omitted. In other words, the flow in FIG. 10B only repairs faults in the pixel unit memory 102.

Specifically, in flow 505′ of FIG. 10B, steps 5051 to 5054 are similar to those in FIG. 10A. In step 5055′, the pixel unit logic circuit 101 directly controls the sub-pixel driving circuits using dimming signals to generate the driving currents (IdrvR, IdrvG, IdrvB) to drive the LEDS (LEDR, LEDG, LEDB).

FIG. 10C shows a flowchart of a display procedure according to one embodiment of the display apparatus of the present invention. Please also refer to FIG. 4. This embodiment is similar to the flow in FIG. 10A, and differs in that the redundant pixel memory in the pixel unit memory 102 in FIG. 4 is omitted. Therefore, the flow in FIG. 10C only performs repairs for faults in the sub-pixel driving circuits. Specifically, in flow 505″ of FIG. 10C, in step 5052′, the pixel unit logic circuit 101 writes the display data only into the pixel unit memory 102 (which includes only the primary pixel memory as in FIG. 4). In step 5053′, the pixel unit logic circuit 101 reads the display data only from the pixel unit memory 102.

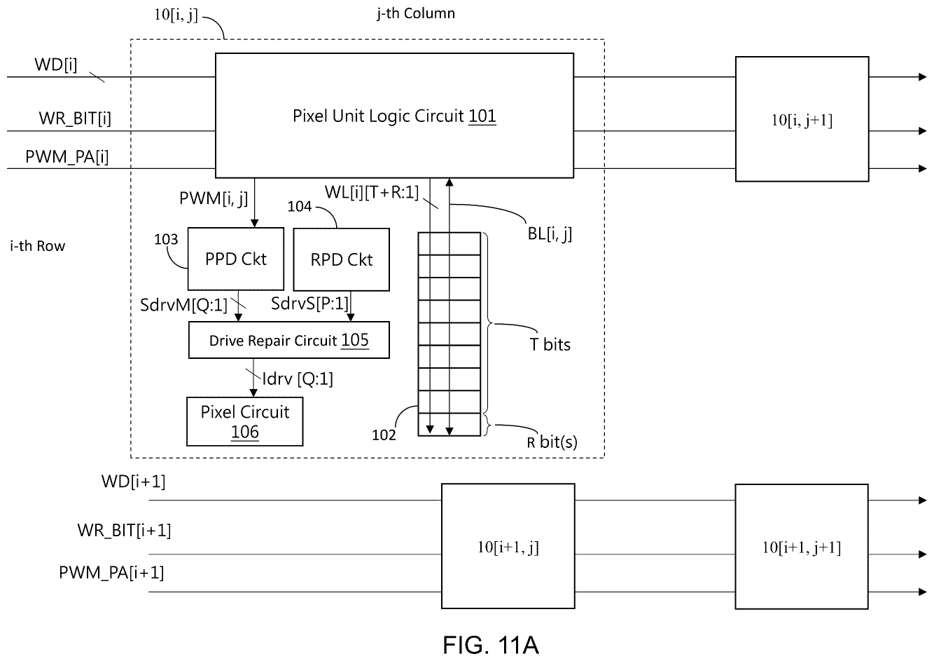

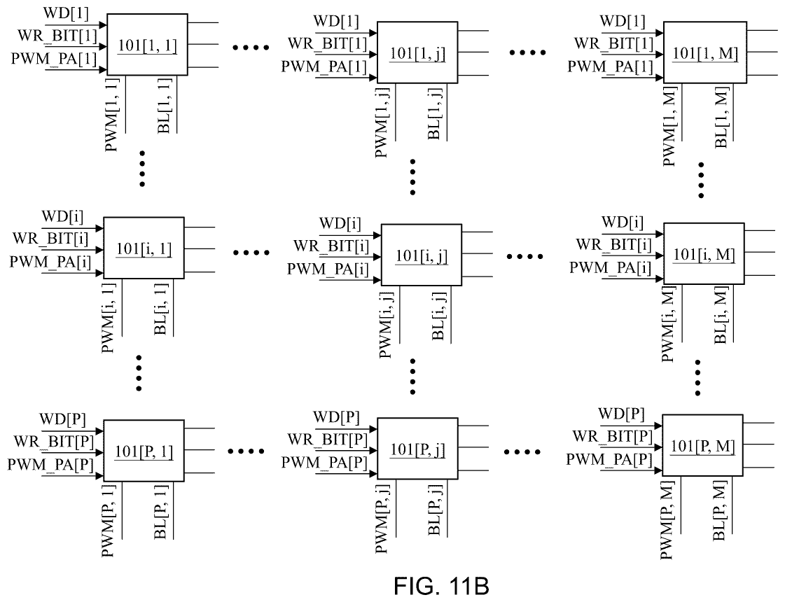

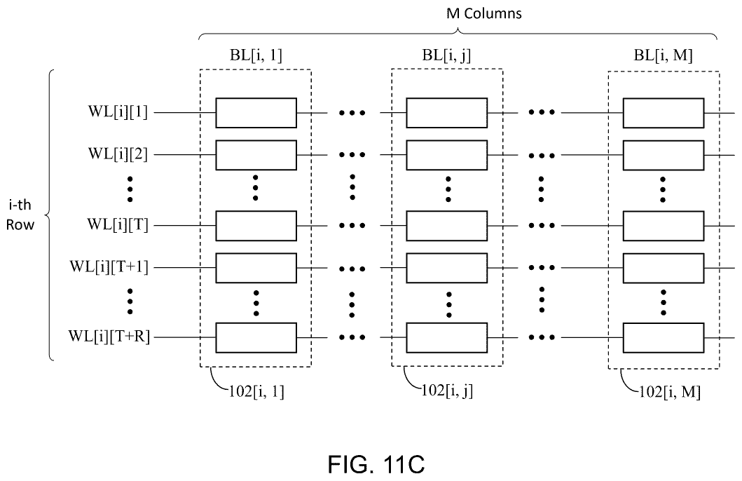

FIG. 11A illustrates the structure of a display pixel unit according to one embodiment of the present invention and shows how the pixel unit logic circuit 101 receives and generates control signals to control various circuit elements within the display pixel unit 10. Please also refer to FIGS. 1 and 2. In this embodiment, the display pixel unit 10 mainly includes a pixel unit logic circuit 101, a pixel unit memory 102, a primary pixel driving circuit (PPD Ckt) 103, a redundant pixel driving circuit (RPD Ckt) 104, a drive repair circuit 105, and a pixel circuit 106.

In the i-th row, the pixel unit logic circuit 101 receives multiple input signals, including a serial word data signal WD, a serial bit write trigger signal WR_BIT, and a pulse-width reference signal PWM_PA, and generates corresponding output control signals accordingly, including a dimming signal PWM, a bit trigger signal WL, and a serial bit line signal BL. The dimming signal PWM corresponds to the dimming signals mentioned above, such as PWR, PWG, or PWB. In this embodiment, one dimming signal is used as an example to illustrate the generation and application of PWM. The bit trigger signal WL and the serial bit line signal BL are mainly used to control the pixel unit memory 102 for storing and reading display data, and thus control the driving operation of the driving circuits.

FIG. 11B illustrates an array of pixel unit logic circuits 101 composed of P rows and M columns. For example, in the i-th row and j-th column, the corresponding pixel unit logic circuit is 101. As described above, each pixel unit logic circuit 101 receives the serial word data signal WD, the serial bit write trigger signal WR_BIT, and the pulse-width reference signal PWM_PA from its corresponding row and generates the corresponding dimming signal PWM and the serial bit line signal BL accordingly.

FIG. 11C illustrates a specific embodiment of a display pixel memory according to one embodiment of the present invention. This embodiment shows pixel unit memories 102 to 102 in the i-th row and M columns. Taking pixel unit memory 102 as an example, it includes a total of T primary memory bits (i.e., primary pixel memory) and R redundant memory bits (i.e., redundant pixel memory), making T+R memory bits in total. For row-direction control, each memory bit is controlled by a corresponding bit trigger signal WL. Specifically, the primary memory bits are controlled by WL to WL, and the redundant memory bits are controlled by WL to WL. For column-direction control, the pixel unit memories 102 to 102 in the i-th row are controlled by corresponding serial bit line signals BL to BL.

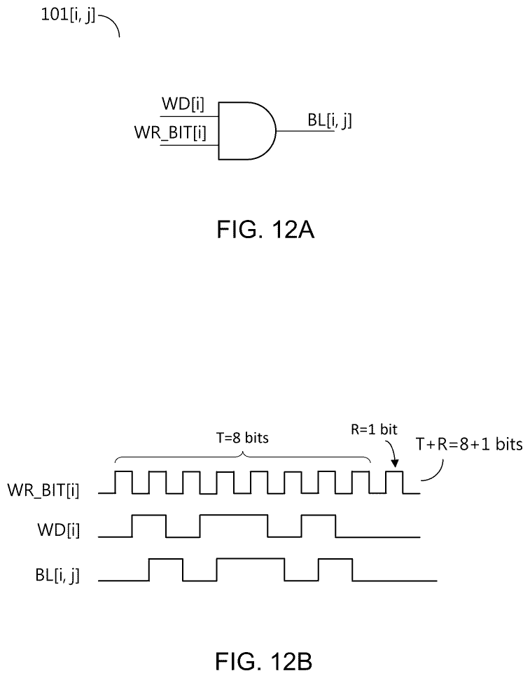

FIG. 12A illustrates a partial circuit diagram of the pixel unit logic circuit 101. In this embodiment, the pixel unit logic circuit 101 includes an AND gate. The AND gate performs a logical AND operation on the serial word data signal WD and the serial bit write trigger signal WR_BIT to generate the serial bit line signal BL.

FIG. 12B illustrates a waveform diagram corresponding to the partial circuit of the pixel unit logic circuit 101 shown in FIG. 12A. In this embodiment, T is set to 8 bits and R is set to 1 bit, so a total of 9 pulses are generated by the serial bit write trigger signal WR_BIT. These pulses act as synchronous trigger pulses to synchronize the serial word data signal WD, and the serial bit line signal BL is ultimately generated through the AND gate operation. In this manner, the waveform of BL is synchronized with WR_BIT.

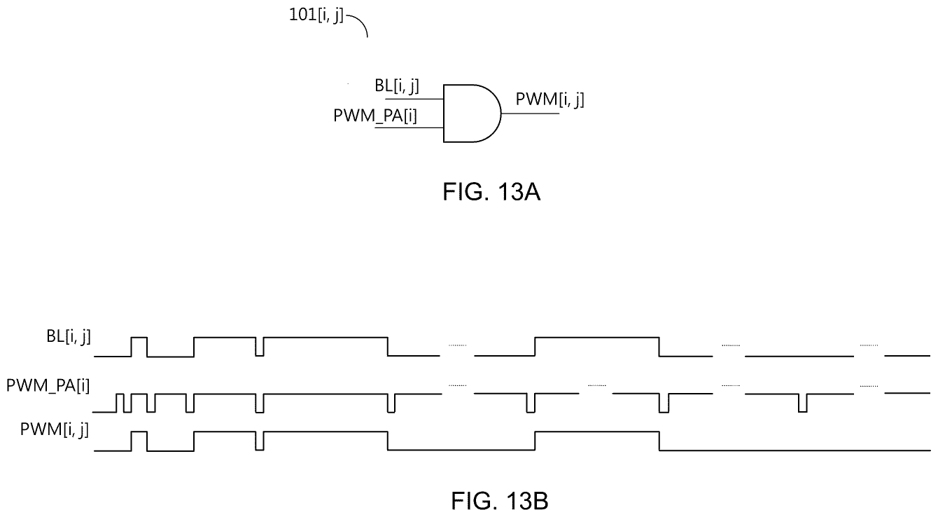

FIG. 13A illustrates a partial circuit of the pixel unit logic circuit 101 according to one embodiment of the present invention, which includes an AND gate. The AND gate receives the serial bit line signal BL and the pulse-width reference signal PWM_PA as inputs and generates the dimming signal PWM through a logical AND operation. FIG. 13B illustrates the corresponding waveform diagram, where the pulse-width reference signal PWM_PA is used as a reference and its pulse width gradually increases in powers of 2, i.e., the duty cycle increases sequentially also in powers of 2. The dimming signal PWM generated by the AND gate depends on the bit value of the serial bit line signal BL (e.g., 1 or 0), and the duration of the enabling level (e.g., high level) is determined by the pulse width of PWM PA, resulting in a dimming signal PWM with a corresponding duty cycle.

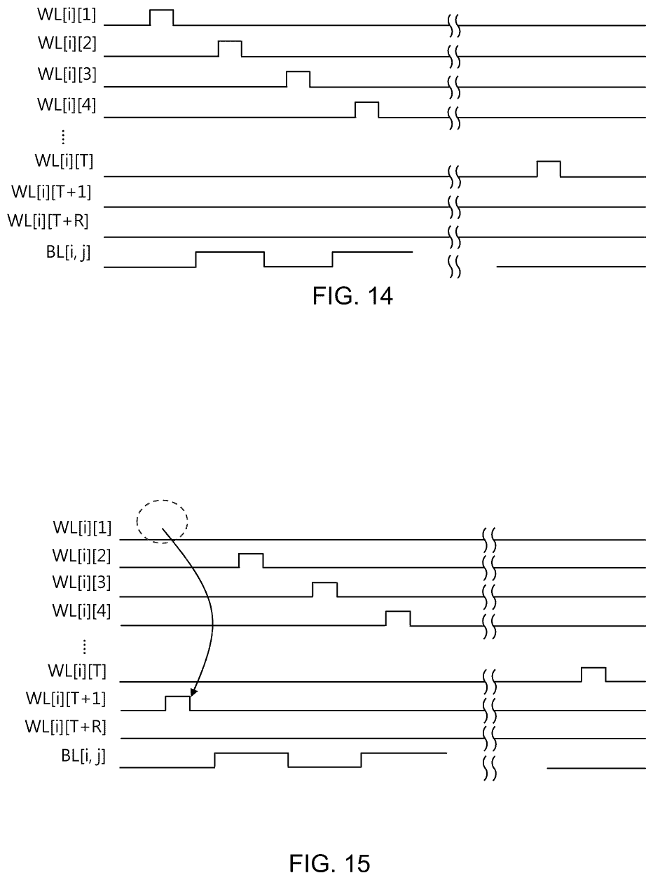

FIG. 14 illustrates the control signal waveforms of the pixel unit memory 102 according to one embodiment of the present invention, taking pixel unit memory 102 as an example. It shows the waveforms of the bit trigger signals WL to WL and WL to WL and the serial bit line signal BL, which control the memory bits. Specifically, WL to WL are configured to control the T primary memory bits, while WL to WL are configured to control the R redundant memory bits. In this embodiment, for example, R is set to 2, indicating that pixel unit memory 102 has two redundant memory bits. Since all primary memory bits are assumed functioning normally in this embodiment, WL to WL generate corresponding pulses in sequence during the write timing to sequentially write the data provided by the pixel unit logic circuit 101 into the T primary memory bits.

FIG. 15 illustrates a waveform diagram of a fault condition, which is similar to FIG. 14. In this embodiment, it is assumed that the first primary memory bit is faulty and cannot function properly. During write or read operations, the pulse that should have been generated by WL (as shown by the dashed circle) is replaced by the pulse from WL, allowing the data originally intended for the first primary memory bit to be written into the first redundant memory bit instead.

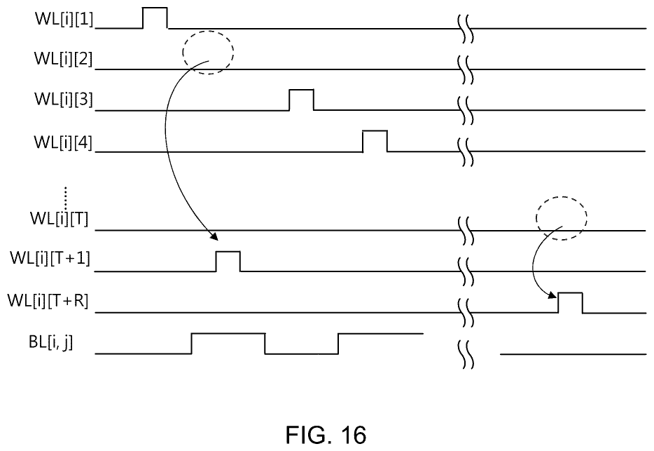

FIG. 16 further illustrates another fault condition waveform, where it is assumed that two primary memory bits in pixel unit memory 102 are faulty, specifically at the 2nd and T-th bit positions. In this case, the bit trigger signals WL and WL, which originally control the 2nd and T-th primary memory bits, are disabled (as shown by the dashed circles). Instead, the pulses generated by WL and WL at the corresponding time points are configured to control the writing of data, allowing the data originally intended for the 2nd and T-th primary memory bits to be written into the first and second redundant memory bits, respectively.

The present invention has been described in considerable detail with reference to certain preferred embodiments thereof. It should be understood that the description is for illustrative purpose, not for limiting the broadest scope of the present invention. An embodiment or a claim of the present invention does not need to achieve all the objectives or advantages of the present invention. The title and abstract are provided for assisting searches but not for limiting the scope of the present invention. Those skilled in this art can readily conceive variations and modifications within the spirit of the present invention. For example, to perform an action “according to” a certain signal as described in the context of the present invention is not limited to performing an action strictly according to the signal itself, but can be performing an action according to a converted form or a scaled-up or down form of the signal, i.e., the signal can be processed by a voltage-to-current conversion, a current-to-voltage conversion, and/or a ratio conversion, etc. before an action is performed. It is not limited for each of the embodiments described hereinbefore to be used alone; under the spirit of the present invention, two or more of the embodiments described hereinbefore can be used in combination. For example, two or more of the embodiments can be configured together, or, a part of one embodiment can be configured to replace a corresponding part of another embodiment. In view of the foregoing, the spirit of the present invention should cover all such and other modifications and variations, which should be interpreted to fall within the scope of the following claims and their equivalents.

What is claimed is:

1. A display apparatus, comprising:
a display module including a plurality of display pixel units physically arranged in M columns and P rows, and at least one redundant pixel driving circuit;
a nonvolatile memory; and
a drive control circuit configured to control the display module to execute a pixel unit redundancy repair procedure for obtaining and storing repair data in the nonvolatile memory, and configured to, during a display procedure, read the repair data from the nonvolatile memory and control the plurality of display pixel units and the at least one redundant pixel driving circuit for image display based on the repair data and display data.

2. The display apparatus of claim 1, wherein each of the plurality of display pixel units comprises:
a pixel unit memory configured to store a portion of the display data corresponding to the display pixel unit;
a primary pixel driving circuit including Q sub-pixel driving circuits, where Q is an integer greater than or equal to 1;
a drive repair circuit coupled to the primary pixel driving circuit and the at least one redundant pixel driving circuit;
a pixel circuit coupled to the drive repair circuit, including Q corresponding light-emitting diodes (LEDs); and
a pixel unit logic circuit coupled to the pixel unit memory, the primary pixel driving circuit, and the at least one redundant pixel driving circuit;
wherein during the display procedure, the pixel unit logic circuit, under control of the drive control circuit, reads and converts the corresponding portion of the display data from the pixel unit memory to generate a dimming signal, and when at least one of the Q sub-pixel driving circuits is determined to be faulty, the pixel unit logic circuit controls the drive repair circuit based on the repair data to electrically connect the non-faulty portion of the Q sub-pixel driving circuits and the at least one redundant pixel driving circuit to the corresponding Q LEDs, and controls the non-faulty portion of the Q sub-pixel driving circuits and the at least one redundant pixel driving circuit based on the dimming signal to generate Q corresponding driving currents for driving the Q LEDs to emit light.

3. The display apparatus of claim 1, wherein each of the display pixel units further includes one of the at least one redundant pixel driving circuit; or wherein the display module includes R′ redundant pixel driving circuits, where R′ is greater than 1 and less than the product of M and P, such that each of the R′ redundant pixel driving circuits is shared by a predetermined number of the display pixel units.

4. The display apparatus of claim 2, wherein the pixel unit redundancy repair procedure includes a driving circuit redundancy repair procedure, the driving circuit redundancy repair procedure includes:
controlling, by the drive control circuit, at least one of the Q sub-pixel driving circuits to generate a test current for driving the corresponding light-emitting diode to emit light;
determining whether the sub-pixel driving circuit is faulty based on the brightness of the light-emitting diode or the level of the test current; and
when determined to be faulty, determining corresponding repair data based on a driver fault address of the faulty sub-pixel driving circuit, wherein the repair data includes the driver fault address and mapping information to a corresponding one of the at least one redundant pixel driving circuits as a replacement.

5. The display apparatus of claim 2, wherein each of the sub-pixel driving circuits and the at least one redundant pixel driving circuit includes:
a reference drive current source and a dimming transistor serially coupled to the drive repair circuit;
wherein during the display procedure, the pixel unit logic circuit is configured to control the dimming transistor based on the dimming signal to generate the driving current from the reference drive current source, thereby driving the corresponding light-emitting diode to emit light with a corresponding intensity.

6. The display apparatus of claim 5, wherein the dimming signal is configured to linearly control or pulse-width modulate the dimming transistor to adjust the light intensity of the light-emitting diode.

7. The display apparatus of claim 5, wherein the drive repair circuit includes a plurality of path control switches coupled among the Q sub-pixel driving circuits, the at least one redundant pixel driving circuit, and the Q light-emitting diodes, and wherein the pixel unit logic circuit is configured to generate corresponding path control signals based on the repair data to control the path control switches so as to turn off the faulty sub-pixel driving circuit and turn on a corresponding one of the at least one redundant pixel driving circuit to generate the corresponding driving current for driving the corresponding light-emitting diode to emit light.

8. The display apparatus of claim 1, wherein the pixel unit memory includes:
a primary pixel memory including T primary memory bits, where T is an integer greater than or equal to 1; and
a redundant pixel memory including R redundant memory bits, where R is an integer greater than or equal to 1;
wherein during the display procedure, when at least one of the T primary memory bits is determined to be faulty, the pixel unit logic circuit controls the non-faulty portion of the T primary memory bits and the R redundant memory bits to collaborate based on the repair data for storing or retrieving the display data.

9. The display apparatus of claim 8, wherein the pixel unit redundancy repair procedure includes a pixel memory redundancy repair procedure, the pixel memory redundancy repair procedure includes:
performing, by the drive control circuit, a read/write test on the primary pixel memory to determine whether any of the primary memory bits are faulty; and
when a fault is determined, determining corresponding repair data based on a memory bit fault address of the faulty one of the primary memory bits, wherein the repair data includes the memory bit fault address and mapping information to a corresponding one of the redundant memory bits as a replacement.

10. The display apparatus of claim 2, wherein the display module and the drive control circuit are integrally manufactured on a single chip, and the pixel unit memory, the primary pixel driving circuit, the drive repair circuit, the pixel circuit, the pixel unit logic circuit, and the corresponding one of the at least one redundant pixel driving circuit within each of the display pixel units are physically located in proximity to one another.

11. A display apparatus, comprising:
a display module including a plurality of display pixel units physically arranged in M columns and P rows, wherein each of the plurality of display pixel units includes a pixel unit memory and a pixel unit logic circuit, the pixel unit memory configured to store a portion of display data corresponding to the display pixel unit, and the pixel unit logic circuit being coupled to the pixel unit memory,
wherein the pixel unit memory comprises:
a primary pixel memory including T primary memory bits, where T is an integer greater than or equal to 1; and
a redundant pixel memory including R redundant memory bits, where R is an integer greater than or equal to 1;
a nonvolatile memory; and
a drive control circuit configured to control the display module to execute a pixel memory redundancy repair procedure for obtaining and storing repair data in the nonvolatile memory, and configured to, during a display procedure, read the repair data from the nonvolatile memory and control the plurality of display pixel units to perform image display based on the repair data and the display data;
wherein during the display procedure, when at least one of the T primary memory bits is determined to be faulty, the pixel unit logic circuit controls the non-faulty portion of the T primary memory bits and the R redundant memory bits to cooperate based on the repair data for storing or retrieving the display data.

12. The display apparatus of claim 11, wherein the pixel unit redundancy repair procedure includes a pixel memory redundancy repair procedure, the pixel memory redundancy repair procedure includes:
performing, by the drive control circuit, a read/write test on the primary pixel memory to determine whether any of the primary memory bits are faulty; and
when a fault is determined, determining corresponding repair data based on a memory bit fault address of the faulty one of the primary memory bits, wherein the repair data includes the memory bit fault address and mapping information to a corresponding one of the redundant memory bits as a replacement.

13. A display control method for controlling a display module, wherein the display module includes a plurality of display pixel units physically arranged in M columns and P rows and at least one redundant pixel driving circuit, the display control method comprising:
controlling the display module to execute a pixel unit redundancy repair procedure to obtain and store repair data in a nonvolatile memory; and
during a display procedure, reading the repair data from the nonvolatile memory and controlling the plurality of display pixel units and the at least one redundant pixel driving circuit to perform image display based on the repair data and display data.

14. The display control method of claim 13, wherein each of the plurality of display pixel units includes a pixel unit memory configured to store a portion of the display data corresponding to the display pixel unit, wherein the display procedure includes:
reading and converting the portion of the display data from the pixel unit memory to generate a dimming signal,
wherein each of the display pixel units further includes a primary pixel driving circuit and the at least one redundant pixel driving circuit, and the primary pixel driving circuit includes Q sub-pixel driving circuits, where Q is an integer greater than or equal to 1;
when at least one of the Q sub-pixel driving circuits in the primary pixel driving circuit is determined to be faulty, controlling, based on the repair data, the non-faulty portion of the Q sub-pixel driving circuits and the redundant pixel driving circuit to be electrically connected to a pixel circuit including corresponding Q light-emitting diodes (LEDs); and
controlling, based on the dimming signal, the non-faulty portion of the Q sub-pixel driving circuits and the redundant pixel driving circuit to generate Q corresponding driving currents to drive the Q LEDs to emit light.

15. The display control method of claim 14, wherein the pixel unit redundancy repair procedure includes a driving circuit redundancy repair procedure, the driving circuit redundancy repair procedure comprising:
controlling at least one of the Q sub-pixel driving circuits to generate a test current for driving the corresponding light-emitting diode to emit light;
determining whether the sub-pixel driving circuit is faulty based on the brightness of the light-emitting diode or the level of the test current; and
when determined to be faulty, determining corresponding repair data based on a driver fault address of the faulty sub-pixel driving circuit, wherein the repair data includes the driver fault address and mapping information to a corresponding one of the at least one redundant pixel driving circuit as a replacement.

16. The display control method of claim 14, wherein the dimming signal is configured to linearly control or pulse-width modulate a dimming transistor of each of the sub-pixel driving circuits and the redundant pixel driving circuit to adjust the light intensity of the light-emitting diode.

17. The display control method of claim 14, wherein the display procedure includes:
disabling the at least one faulty sub-pixel driving circuit based on the repair data, and
controlling the redundant pixel driving circuit to generate the corresponding driving current to drive the corresponding light-emitting diode to emit light.

18. The display control method of claim 14, wherein the pixel unit memory includes:
a primary pixel memory including T primary memory bits, where T is an integer greater than or equal to 1; and
a redundant pixel memory including R redundant memory bits, where R is an integer greater than or equal to 1;
wherein the display procedure includes: when at least one of the T primary memory bits is determined to be faulty, controlling, based on the repair data, the non-faulty portion of the T primary memory bits and the R redundant memory bits to collaborate to store or retrieve the display data.

19. The display control method of claim 18, wherein the pixel unit redundancy repair procedure includes a pixel memory redundancy repair procedure, the pixel memory redundancy repair procedure comprising:
performing a read/write test on the primary pixel memory to determine whether any of the primary memory bits are faulty; and
when a fault is determined, determining corresponding repair data based on a memory bit fault address of the faulty one of the primary memory bits, wherein the repair data includes the memory bit fault address and mapping information to corresponding one of the redundant memory bits as a replacement.

20. The display control method of claim 14, wherein the pixel unit memory, the primary pixel driving circuit, the pixel circuit, and the corresponding redundant pixel driving circuit in each of the display pixel units are physically located in proximity to one another.

21. A display control method for controlling a display module, wherein the display module includes a plurality of display pixel units physically arranged in M columns and P rows, the display control method comprising:
controlling the display module to execute a pixel memory redundancy repair procedure to obtain and store repair data in a nonvolatile memory,
wherein each of the plurality of display pixel units includes a pixel unit memory configured to store a portion of display data corresponding to the display pixel unit, and the pixel unit memory includes:
a primary pixel memory including T primary memory bits, where T is an integer greater than or equal to 1; and
a redundant pixel memory including R redundant memory bits, where R is an integer greater than or equal to 1; and
during a display procedure, reading the repair data from the nonvolatile memory and controlling the plurality of display pixel units to perform image display based on the repair data and the display data;
wherein the display procedure includes: when at least one of the T primary memory bits is determined to be faulty, controlling, based on the repair data, the non-faulty portion of the T primary memory bits and the R redundant memory bits to collaborate to store or retrieve the display data.

22. The display control method of claim 21, wherein the pixel unit redundancy repair procedure includes a pixel memory redundancy repair procedure, the pixel memory redundancy repair procedure includes:
performing a read/write test on the primary pixel memory to determine whether any of the primary memory bits are faulty; and
when a fault is determined, determining corresponding repair data based on a memory bit fault address of the faulty one of the primary memory bits, wherein the repair data includes the memory bit fault address and mapping information to a corresponding one of the redundant memory bits as a replacement.
